(19) United States
(12) Patent Application Publication
(10) Pub. No.: US 2025/0311657 A1
(43) Pub. Date: Oct. 9, 2025

(54) FARM FIELD REGISTRATION DEVICE, FARM FIELD REGISTRATION METHOD, AND COMPUTER PROGRAM

(71) Applicant: Kubota Corporation, Osaka (JP)

(72) Inventor: Kenji TAMATANI, Sakai-shi (JP)

(21) Appl. No.: 19/245,657

(22) Filed: Jun. 23, 2025

Related U.S. Application Data
(63) Continuation of application No. PCT/JP2023/046303, filed on Dec. 25, 2023.

(30) Foreign Application Priority Data
Dec. 27, 2022 (JP) 2022-209623

(51) Int. Cl. A01B 79/00; A01B 69/04; G01C 21/00

(52) U.S. Cl. CPC A01B 79/005; A01B 69/008; G01C 21/3826; G01C 21/3896

(57) ABSTRACT

A farm field registration device includes an acquisition device configured to acquire boundary information for defining a boundary line of a farm field, a controller configured or programmed to create a farm field map in a predetermined data format based on the boundary information, and a storage device configured to store the farm field map. The acquisition device is configured to acquire division information for defining a division line that divides the farm field into a plurality of divided farm fields each including a plantable area, the controller is configured or programmed to execute division processing of creating a divided farm field map corresponding to the plurality of divided farm fields based on the division information, and the storage device is configured to store the divided farm field map.

### CROSS REFERENCE TO RELATED APPLICATIONS

This application claims the benefit of priority to Japanese Patent Application No. 2022-209623 filed on Dec. 27, 2022 and is a Continuation Application of PCT Application No. PCT/JP2023/046303 filed on Dec. 25, 2023. The entire contents of each application are hereby incorporated herein by reference.

### BACKGROUND OF THE INVENTION

### 1. Field of the Invention

The present disclosure relates to farm field registration devices, farm field registration methods, and non-transitory computer-readable media including computer programs.

### 2. Description of the Related Art

Japanese Laid-Open Patent Publication No. 2022-102335 describes a paddy field work machine capable of easily confirming and changing a work plan and improving traveling safety.

A paddy field work machine of Japanese Laid-Open Patent Publication No. 2022-102335 includes a traveling vehicle body, a work device connected to the traveling vehicle body and configured to perform predetermined work on a farm field, an acquisition device of position information of the traveling vehicle body, and a controller that causes the traveling vehicle body to automatically perform traveling including the acquired position information and turning.

The controller acquires farm field information based on the acquired position information when causing the vehicle body to manually travel along at least three sides of the farm field, and causes the traveling vehicle body to automatically travel according to the acquired farm field information while displaying the farm field information on a display device provided in the traveling vehicle body.

### SUMMARY OF THE INVENTION

A device according to an example embodiment of the present disclosure is a farm field registration device including an acquisition device configured to acquire boundary information for defining a boundary line of a farm field, a controller configured or programmed to create a farm field map in a predetermined data format based on the boundary information, and a storage device configured to store the farm field map, in which the acquisition device is configured to acquire division information for defining a division line that divides the farm field into a plurality of divided farm fields each including a plantable area, the controller is configured or programmed to execute division processing of creating a divided farm field map corresponding to the plurality of divided farm fields based on the division information, and the storage device is configured to store the divided farm field map.

A method according to an example embodiment of the present disclosure is a method executed by a farm field registration device including an acquisition device configured to receive input of boundary information for defining a boundary line of a farm field, a controller configured or programmed to create a farm field map in a predetermined data format based on the boundary information, and a storage device configured to store the farm field map, and the method includes acquiring division information for defining a division line that divides the farm field into a plurality of divided farm fields each including a plantable area, executing division processing of calculating a divided farm field map corresponding to the plurality of divided farm fields based on the division information, and storing the divided farm field map.

A non-transitory computer-readable medium according to an example embodiment of the present disclosure includes a computer program to cause a computer to function as a farm field registration device including an acquisition device configured to receive input of boundary information for defining a boundary line of a farm field, a controller configured or programmed to create a farm field map in a predetermined data format based on the boundary information, and a storage device configured to store the farm field map, and the computer program causes the farm field registration device to perform a method including acquiring division information for defining a division line that divides the farm field into a plurality of divided farm fields each including a plantable area, executing division processing of calculating a divided farm field map corresponding to the plurality of divided farm fields based on the division information, and storing the divided farm field map.

Example embodiments of the present disclosure can be implemented by a device, a system, a method, an integrated circuit, a computer program, a non-transitory computer-readable recording medium, or any combination thereof.

The properties of the recording medium may be either volatile or nonvolatile. The device may include a plurality of individual devices. In the case of a configuration including a plurality of individual devices, the individual devices may be arranged in one housing, or may be arranged separately in two or more separate housings.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an overall configuration diagram of a work support system.

FIG. 2 is a side view illustrating an example of a tractor.

FIG. 3 is a perspective view illustrating an example of an operation terminal and an operation switch group.

FIG. 4 is an explanatory view illustrating an example of a setting screen of a work plan.

FIG. 5 is an explanatory view illustrating an example of a notification screen of the work plan.

FIG. 6 is an explanatory diagram illustrating an example of an initial setting screen and a division setting screen.

FIG. 7 is an explanatory diagram illustrating an example of the division setting screen and a content confirmation screen.

FIG. 8 is an explanatory diagram illustrating an example of the content confirmation screen and a route setting screen.

FIG. 9 is an explanatory diagram illustrating an example of registration processing of a farm field map.

FIG. 10 is an explanatory diagram illustrating an example of division processing of the farm field map.

FIG. 11 is an explanatory diagram illustrating an example of generation processing of a travel route.

### DETAILED DESCRIPTION OF THE EXAMPLE EMBODIMENTS

For example, in upland farming, two or more kinds of crops may be planted in one farm field. In addition, a work plan including the correspondence relationship between a farm field and the crop, the harvest amount of the crop, and the like can vary from year to year.

Therefore, there is a demand for changing the area of the farm field once determined at the beginning of the year or changing the type of crops to be planted in the farm field. In this regard, in Japanese Laid-Open Patent Publication No. 2022-102335, farm field information is uniformly determined for rice cultivation, and changes in area and planting variety are not assumed.

In view of such conventional problems, example embodiments of the present disclosure easily change a farm field map once registered.

According to example embodiments of the present disclosure, the farm field map once registered can be easily changed.

Hereinafter, a summary of example embodiments of the present disclosure will be listed and described.

A device according to the present example embodiment is a farm field registration device including an acquisition device configured to acquire boundary information for defining a boundary line of a farm field, a controller configured or programmed to create a farm field map in a predetermined data format based on the boundary information, and a storage device configured to store the farm field map, in which the acquisition device is configured to acquire division information for defining a division line that divides the farm field into a plurality of divided farm fields each including a plantable area, the controller is configured or programmed to execute division processing of creating a divided farm field map corresponding to the plurality of divided farm fields based on the division information, and the storage device is configured or programmed to store the divided farm field map.

According to the farm field registration device of the present example embodiment, since the controller is configured or programmed to execute the division processing of creating the divided farm field map corresponding to the plurality of divided farm fields based on the division information for defining the division line that divides the farm field into the plurality of divided farm fields and the storage device is configured or programmed to store the created divided farm field map, the farm field map once registered can be easily changed.

In the farm field registration device of the present example embodiment, in a case where the division information includes areas of the plurality of divided farm fields, the division processing may include processing of determining, based on the areas, a position of the division line by moving at least one side of the farm field map in parallel to a center side.

In this way, since the position of the division line is automatically determined only by inputting the areas, setting input of the division information necessary for creating the farm field map is simplified.

In the farm field registration device of the present example embodiment, in a case where the acquisition device further acquires types of crops to be planted in the plurality of divided farm fields, the division processing may include processing of determining a map to which one of the types of crops is to be associated among the plurality of divided farm field maps.

In this way, the divided farm field map and the crops to be planted in the divided farm field can be associated with each other automatically.

In the farm field registration device of the present example embodiment, in a case where the farm field registration device is a management device configured to communicate with an agricultural machine configured to perform automatic driving, the management device may be configured to transmit the plurality of divided farm field maps to the agricultural machine.

In this way, since the divided farm field map generated by the management device can be provided to the agricultural machine configured to perform automatic operation, the agricultural machine does not need to generate the divided farm field map.

In the farm field registration device of the present example embodiment, the controller may be configured or programmed to generate a travel route of an agricultural machine in a case where the agricultural machine performs work travel by automatic driving, for each of the plurality of divided farm field maps.

In this way, the travel route corresponding to each divided farm field map can be generated.

In the farm field registration device of the present example embodiment, in a case where the farm field registration device is a management device configured to communicate with an agricultural machine configured to perform automatic driving, the management device may be configured to transmit the travel route generated by the controller to the agricultural machine.

In this way, since the travel route generated by the management device corresponding to the divided farm field map can be provided to the agricultural machine configured to perform automatic driving, the agricultural machine does not need to generate the travel route corresponding to the divided farm field map.

In the farm field registration device of the present example embodiment, in a case where the farm field registration device is an agricultural machine configured to perform automatic driving, the agricultural machine may generate a travel route in a case of performing work travel by automatic driving, for each of the plurality of divided farm field maps received from the management device.

In this way, the agricultural machine can autonomously generate the travel route for the divided farm field map provided from the management device.

In the farm field registration device of the present example embodiment, in a case where the farm field registration device is an agricultural machine configured to perform automatic driving, the agricultural machine may generate a travel route in a case of performing work travel by automatic driving, for each of the plurality of divided farm field maps created by the division processing.

In this way, the agricultural machine can autonomously generate the travel route for the divided farm field map generated by its own machine.

A method according to the present example embodiment is a farm field registration method executed in the farm field registration devices of any of the example embodiments described above.

Therefore, the farm field registration method of the present example embodiment exhibits the operational effects similar to those of the farm field registration devices of the example embodiments described above.

A non-transitory computer-readable medium according to the present example embodiment includes a computer program that causes a computer to function as the farm field registration devices according to the example embodiments described above.

Therefore, the non-transitory computer-readable medium including the computer program of the present example embodiment exhibits the operational effects similar to those of the farm field registration devices of the example embodiments described above.

Hereinafter, example embodiments of the present disclosure will be described in detail with reference to the drawings. Note that at least a portion of the example embodiments described below may be arbitrarily combined.

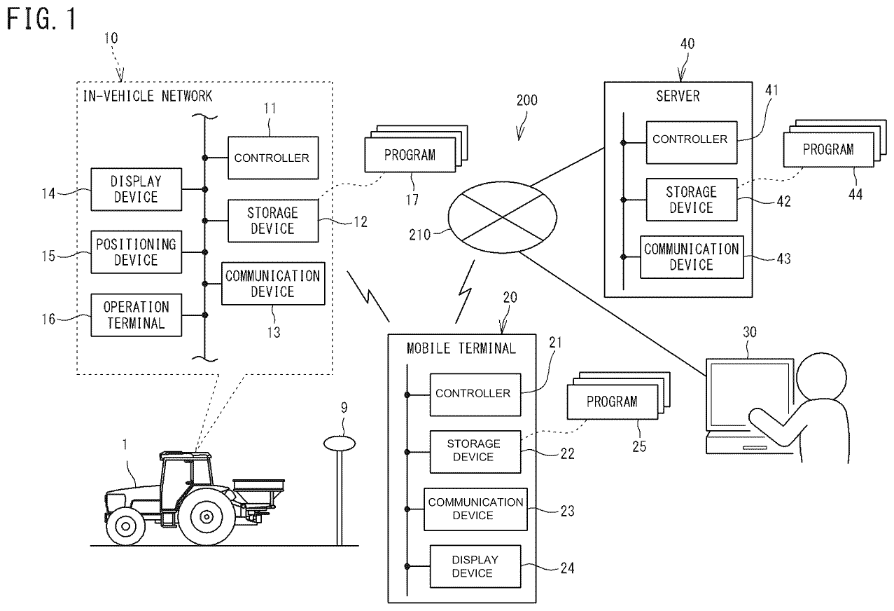

FIG. 1 is an overall configuration diagram of a work support system 200 according to the present example embodiment.

The work support system (hereinafter, also referred to as “support system”) 200 of the present example embodiment is a system in which a mobile terminal 20, a management terminal 30, a server 40, and the like cooperate to support the agricultural works performed by a work vehicle 1 on the ground. The support system 200 includes the work vehicle 1, the mobile terminal 20, the management terminal 30, and the server 40 as communication nodes for exchanging information.

The work vehicle 1, the mobile terminal 20, the management terminal 30, and the server 40 are communicably connected by a public communication network 210 including the Internet and the like. The connection between the mobile terminal 20 and the public communication network 210 may include wireless communication such as a mobile communication system.

The mobile terminal 20 is also communicably connected to an in-vehicle network 10 of the work vehicle 1. The communication connection between the mobile terminal 20 and the in-vehicle network 10 may be either wireless or wired.

The mobile terminal 20 is, for example, a wireless terminal assigned to a worker who uses the work vehicle 1. When performing work, the worker carries the mobile terminal 20 and boards the work vehicle 1.

The management terminal 30 is, for example, a personal computer (PC) assigned to an administrator who manages one or a plurality of work vehicles 1 and the worker who is an occupant thereof. The administrator is a main user of the support system 200 registered in advance as a member, in the server 40.

The server 40 can communicate with the work vehicle 1, the mobile terminal 20, and the management terminal 30. The server 40 is configured or programmed to perform a function as a “management device” that creates a work plan of the work vehicle 1 and creates a farm field map based on setting information and the like input from the management terminal 30.

The “work plan” is a data group that defines a schedule (information including the contents of 5W1H) of near future work performed by the work vehicle 1 in a predetermined work region. The “farm field map” is a data group in a predetermined data format representing the position and shape of the farm field included in the farm.

The work vehicle 1 of the present example embodiment is, for example, an agricultural machine. Examples of the agricultural machine include a tractor, a combine harvester, a rice transplanter, and the like. In the present example embodiment, the work vehicle 1 is assumed to be a tractor 1 that is a type of agricultural machine.

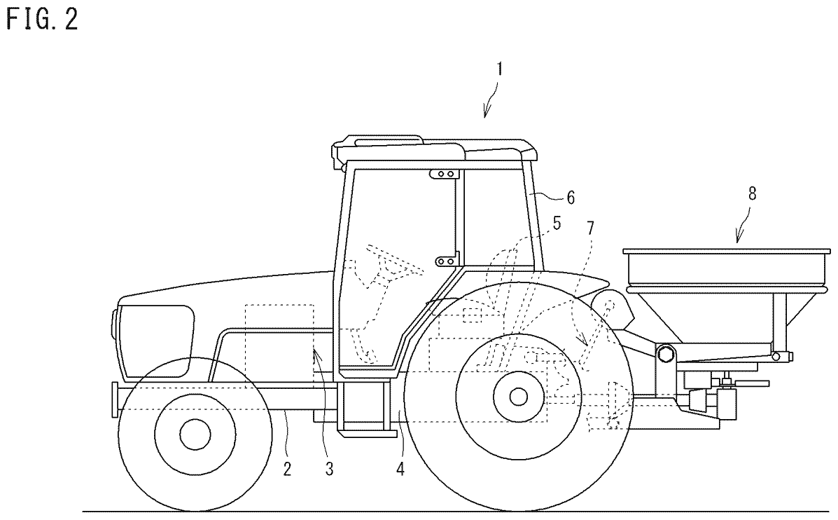

FIG. 2 is a side view illustrating an example of the tractor 1. As illustrated in FIG. 2, the tractor 1 includes a traveling vehicle body 2 including four wheels, a prime mover 3 such as a diesel engine, and a transmission device 4. The traveling vehicle body 2 is mounted with a driver's seat 5 and a cabin 6 surrounding the driver's seat 5.

A coupling portion 7 including, for example, a three-point link mechanism is provided behind the traveling vehicle body 2. A work device (also referred to as “implement”) 8 is detachably coupled to the coupling portion 7. When the work device 8 is coupled to the coupling portion 7, the work device 8 can be pulled by the traveling vehicle body 2.

As the work device 8, for example, a tilling device, a fertilizer spraying device, a pesticide spraying device, a harvest device, or the like is adopted. FIG. 2 illustrates an example in which a fertilizer spraying device is attached. The work device 8 coupled to the coupling portion 7 is not limited to the above-described device, and may be another device.

Returning to FIG. 1, the tractor 1 includes the in-vehicle network 10 conforming to a communication standard such as a controller area network (CAN).

The communication nodes of the in-vehicle network 10 include a controller 11, a storage device 12, a communication device 13, a display device 14, a positioning device 15, and an operation terminal 16. These devices 11 to 16 are connected by a predetermined communication cable such as a CAN bus.

The controller 11 is an in-vehicle controller including an electronic control unit (ECU) configured or programmed to control the traveling system and the work system of the tractor 1 based on operation signals output from operation tools (steering, operation lever, operation switch, and the like) near the driver's seat 5 and detection signals from sensors.

For example, the controller 11 raises and lowers the coupling portion 7 in accordance with the operation signal of the operation lever, adjusts the rotation speed of the prime mover 3 in accordance with an accelerator opening, and operates a braking mechanism (not illustrated) in accordance with a brake operation.

The controller 11 is configured or programmed to acquire the current own-vehicle position substantially in real time from the positioning device 15. The controller 11 can be configured or programmed to autonomously control the traveling system and the work system by, for example, automatic driving at level 3 based on the own-vehicle position.

The own-vehicle position of the tractor 1 is used for purposes other than the automatic driving, such as instructing the start position of the tilling work to the worker by the display device 14.

The storage device 12 is an auxiliary storage device including a non-volatile memory such as a hard disk drive (HDD) and a solid state drive (SSD). The storage device 12 may include a flash read only memory (ROM), a universal serial bus (USB) memory, or an SD card. A computer program 17 stored in the storage device 12 includes a program to cause a controller 41 to execute registration of a farm field map, generation and registration of a travel route for automatic driving, and the like.

The communication device 13 is, for example, a gateway configured or programmed to connect the in-vehicle network 10 to an external device.

The communication device 13 performs short-distance or long-distance communication with the external device according to a predetermined communication standard. Specifically, the communication device 13 performs wireless communication by, for example, wireless fidelity (Wi-Fi: registered trademark) conforming to IEEE802.11. However, the communication device 13 may perform wireless communication with the external device through a mobile communication system or the like.

The display device 14 is, for example, a liquid crystal display or an organic EL display provided on a console panel in front of the driver's seat 5.

The display device 14 visually displays predetermined character information and images for the occupant (worker) of the tractor 1 to provide the occupant with information.

The positioning device 15 is a device that measures the own-vehicle position by global navigation satellite system (GNSS) positioning. Specifically, the positioning device 15 is a multi-GNSS receiver corresponding to a plurality of types of satellite positioning systems.

Therefore, the positioning device 15 measures the own-vehicle position by communicating with a satellite of at least one system exemplified below in addition to a global positioning system (GPS).

Examples of satellite positioning systems other than the GPS: “GLONASS” of Russia, “Galileo” of the European Commission, “BeiDou” of China, “Michibiki (QZSS)” of Japan, “IRNSS” of India, “WAAS” of the United States, “EGNOS” of Europe, “MSAS” of Japan, “GAGAN” of India, and the like.

A positioning method of the positioning device 15 may be either single positioning or relative positioning, but relative positioning is preferably employed because high accuracy in units of mm or cm is required in the farm field work.

Therefore, the positioning device 15 may be a mobile station of real-time kinematics (RTK)-GNSS. In this case, the mobile station wirelessly receives correction information from a reference station 9 (see FIG. 1) installed at a point whose coordinates are known, and corrects the detected position based on the received correction information. Therefore, the own-vehicle position can be measured with higher accuracy as compared with the case without correction.

The operation terminal 16 is a terminal device configured to receive an operation related to traveling of the work vehicle 1 and the implement 8. The operation terminal 16 is also referred to as a virtual terminal (VT).

The operation terminal 16 is a tablet-type terminal device including a touch panel type display device, at least one operation button, and the like. The display device is, for example, a liquid crystal display, an organic light emitting diode (OLED) display, or the like.

The occupant of the tractor 1 can execute various operations such as switching on/off of an automatic driving mode, recording or editing of an environmental map, setting of a target route, and switching on/off of the implement 8 by the operation terminal 16.

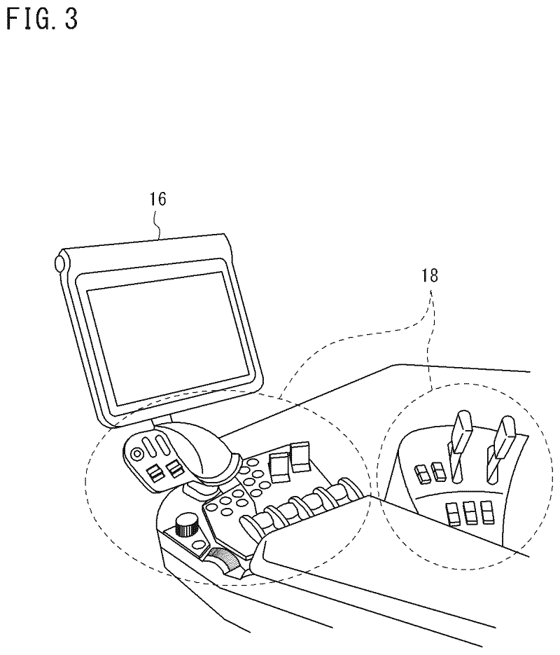

At least some of these operations can also be performed by operating an operation switch group 18 (see FIG. 3). The operation terminal 16 can be configured to be detachable from the work vehicle 1. In this case, the removed operation terminal 16 communicates with the communication device 13 by a short-distance communication method.

FIG. 3 is a perspective view illustrating an example of the operation terminal 16 and the operation switch group 18 installed inside the cabin 6. The switch group 18 including a plurality of switches operable by the occupant is disposed inside the cabin 6.

The operation switch group 18 includes a selection switch to select a shift stage of the main shift or the sub-shift, a mode switching switch to switch an automatic driving mode, a manual driving mode, and the like, a front/rear switch that switches forward movement and backward movement, a raising/lowering switch that raises or lowers the implement 8, and the like.

As illustrated in FIG. 1, the server 40, which is a type of management device of the agricultural machine, is an installation type computer including the controller 41, a storage device 42, and a communication device 43.

The controller 41 may be configured or programmed to include an arithmetic processor including a central processing unit (CPU), a random access memory (RAM), and the like. The controller 41 may include an integrated circuit such as a field-programmable gate array (FPGA).

The controller 41 is configured or programmed to read a computer program 44 stored in the storage device 42 to a main memory (RAM), and perform various types of information processing according to the read program 44.

The storage device 42 is an auxiliary storage device including a nonvolatile memory such as an HDD and an SSD. The storage device 42 may include a flash ROM, a USB memory, or an SD card. The communication device 43 is a communication interface configured to perform communication via the public communication network 210.

The computer program 44 stored in the storage device 42 includes, for example, a program to cause the controller 41 to execute creation and registration of a work plan, registration of a farm field map, generation and registration of a travel route for automatic driving, and the like.

The work plan of the tractor 1 is a data group that defines a schedule (time, work subject, work place, work content, and the like) of near future agricultural works in the farm field. Types of agricultural works include soil making, ridge coating, tilling, rice planting (paddy work), paddling, grooving, weeding, top dressing, harvesting, fertilization, sowing, prevention (chemical spraying), agricultural water (water adjustment), snow removal, and the like.

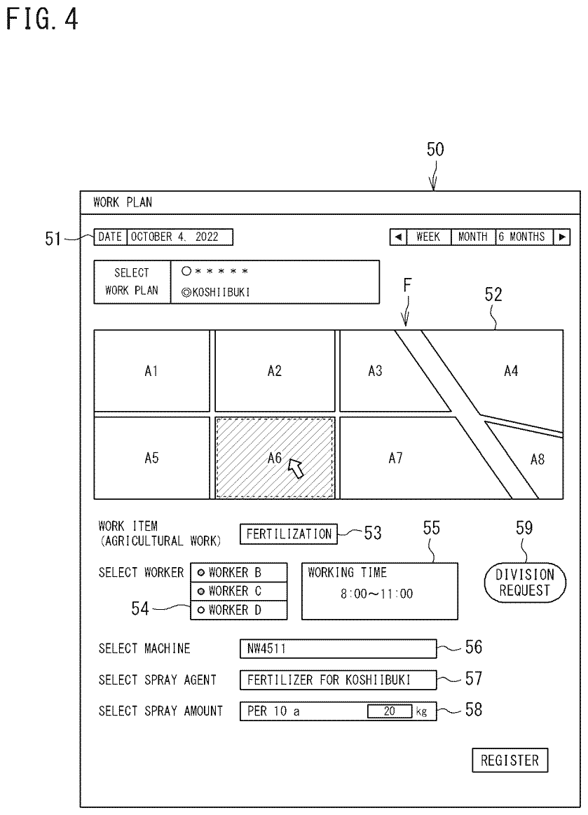

Upon receiving a creation request of the work plan from the management terminal 30, the communication device 43 inputs the received creation request to the controller 41. In response to the input creation request, the controller 41 transmits a predetermined setting screen 50 (see FIG. 4) to the management terminal 30.

Upon receiving a transmission request of the work plan from the mobile terminal 20, the communication device 43 inputs the transmission request to the controller 41. In response to the input transmission request, the controller 41 transmits the created work plan read from the storage device 42 to the mobile terminal 20.

FIG. 4 is an explanatory view illustrating an example of the setting screen 50 of the work plan.

In response to the creation request from the logged-in management terminal 30, the controller 41 of the server 40 causes the management terminal 30 to output the setting screen 50 of the work plan.

As illustrated in FIG. 4, the setting screen 50 of the work plan includes, for example, the following nine setters 51 to 59 as setting items that receives input of setting information by the administrator.

Among the nine setters 51 to 59, a date for performing agricultural works is set in a date setter 51. In a farm field setter 52, a digital map of a farm F including a plurality of farm fields Ai (i=1 to 8 in the illustrated example) in which position information such as a lot number is registered in advance in the storage device 42, is displayed.

By clicking any one of the farm fields Ai included in the digital map in the farm field setter 52, the administrator can designate the position information of the farm field Ai where the tractor 1 performs the agricultural works. FIG. 4 illustrates a case where a hatched farm field A6 is selected.

The position information of the farm field Ai is, for example, a series of position data groups capable of specifying a boundary line representing an extension of the farm field Ai. The series of position data groups includes, for example, coordinate values (latitude value and longitude value) of point groups arranged at predetermined intervals.

A method of setting the farm field Ai in the farm field setter 52 may be a method of inputting identification information on an administrative district such as a lot number or a name of a predetermined farm field defined in advance.

In a work setter 53, the type of agricultural work in the selected farm field Ai is set. For example, the administrator can select one type from the types displayed by a pull-down method. In the example of FIG. 4, “fertilization” is selected.

In a worker setter 54, a list of identification information (for example, names) of workers registered in the management terminal 30 or the server 40, is displayed. The administrator designates the worker who performs the work in the farm field Ai by selecting at least one name from the list.

In a time setter 55, a time zone (start time and end time of the work) of performing the agricultural work is set. In a machine setter 56, the type of the implement 8 used for agricultural works is set. These input methods may be either text input or selection input.

In a spray agent setter 57, the type of spray agent (fertilizer and chemical) to be used for fertilization, top dressing, prevention, and the like is set. In a spray amount setter 58, the spray amount of the spray agent per predetermined area is set. These input methods may also be either text input or selection input.

A division setter 59 is an operation interface to request the server 40 to perform division processing related to one farm field Ai among the plurality of farm fields Ai included in the farm F.

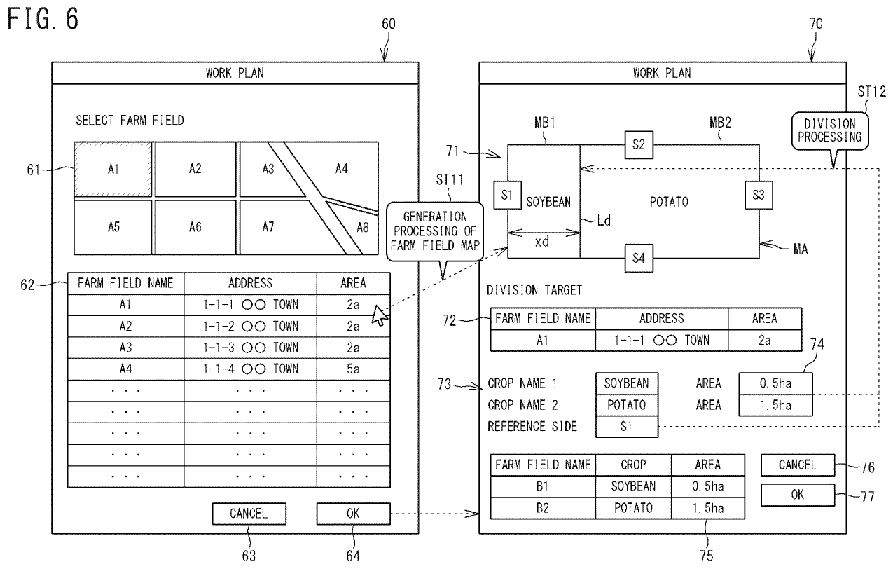

Upon receiving an operation input to the division setter 59, the controller 41 of the server 40 causes the management terminal 30 to display a division setting screen 70 (see FIG. 6) for the division processing. Note that details of the division processing will be described later.

The setting information input to the setters 51 to 58 of the setting screen 50 is transmitted to the server 40. The controller 41 of the server 40 creates a work plan based on the received setting information, and stores the created work plan in a predetermined database of the storage device 42.

In response to the transmission request from the logged-in mobile terminal 20, the controller 41 of the server 40 extracts the work plan including the worker handling the mobile terminal 20 from the storage device 42. The controller 41 transmits the extracted work plan to the mobile terminal 20.

The transmission request of the mobile terminal 20 may include identification information of the farm field Ai scheduled to be worked. In this case, the controller 41 extracts the work plan of the farm field Ai included in the transmission request from the storage device 42, and transmits the extracted work plan to the mobile terminal 20.

As illustrated in FIG. 1, the mobile terminal 20 is a mobile computer including a controller 21, a storage device 22, a communication device 23, and a display device 24. Specifically, the mobile terminal 20 is a smartphone, a tablet-type PC, a notebook-type PC, or the like.

The controller 21 may be configured or programmed to include an arithmetic processor including a CPU, a RAM, and the like. The controller 21 may include an integrated circuit such as an FPGA.

The controller 21 reads a computer program 25 stored in the storage device 22 to a main memory (RAM), and performs various types of information processing according to the read program 25. The storage device 22 is an auxiliary storage device including a nonvolatile memory such as an HDD and an SSD.

The program 25 stored in the storage device 42 includes a program to cause the controller 21 to execute, for example, a transmission request and display processing of the work plan.

The communication device 23 is a communication interface configured to perform both narrow-area communication with the communication device 13 the tractor 1 of and wide-area communication with the server 40. The display device 24 is, for example, a liquid crystal display or an organic EL display on which a user can perform a touch operation.

Upon receiving the work plan from the server 40, the communication device 23 inputs the received work plan to the controller 21. The controller 21 generates a notification screen 24A of the input work plan, and causes the display device 24 to display the generated notification screen 24A.

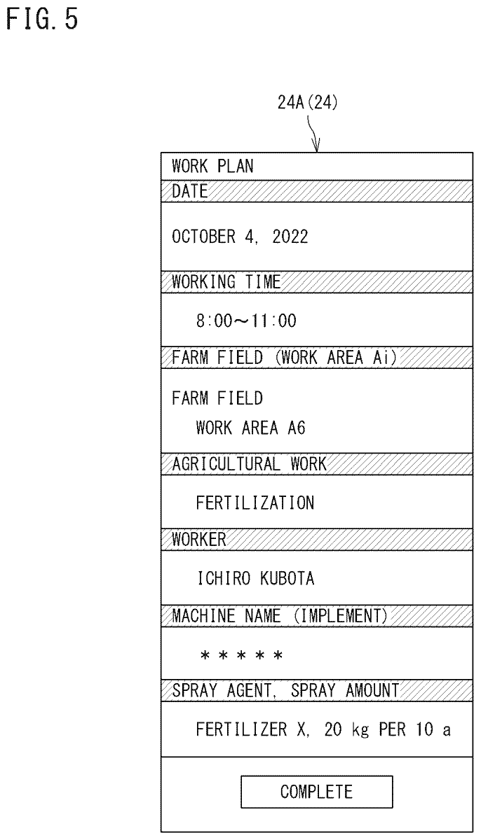

FIG. 5 is an explanatory view illustrating an example of the notification screen 24A of the work plan.

As illustrated in FIG. 5, the notification screen 24A of the work plan displayed by the display device 24 includes, for example, the following display items.

Note that a “complete button” at the bottom of the notification screen 24A is an operation button for notifying the server 40 and the management terminal 30 of work completion.
1) Date of agricultural work (for example, Oct. 4, 2022)
2) Working time of agricultural work (for example, 8:00 to 11:00)
3) Type of farm field (for example, work area A6)
4) Type of agricultural work (for example, fertilization)
5) Worker (for example, Ichiro Kubota)
6) Machine name used for agricultural work
7) Type of spray agent and spray amount (for example, 20 kg of fertilizer X per 10 a)

FIG. 6 to FIG. 8 are explanatory diagrams illustrating examples of a series of setting screens 60, 70, 80, and 90 used for the division processing of the farm field Ai executed by the controller 41 of the server 40.

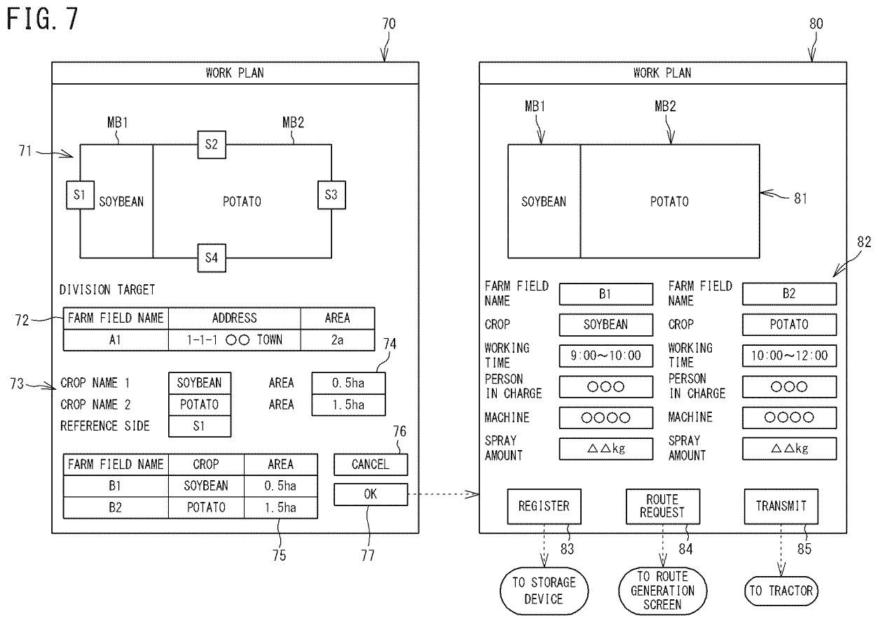

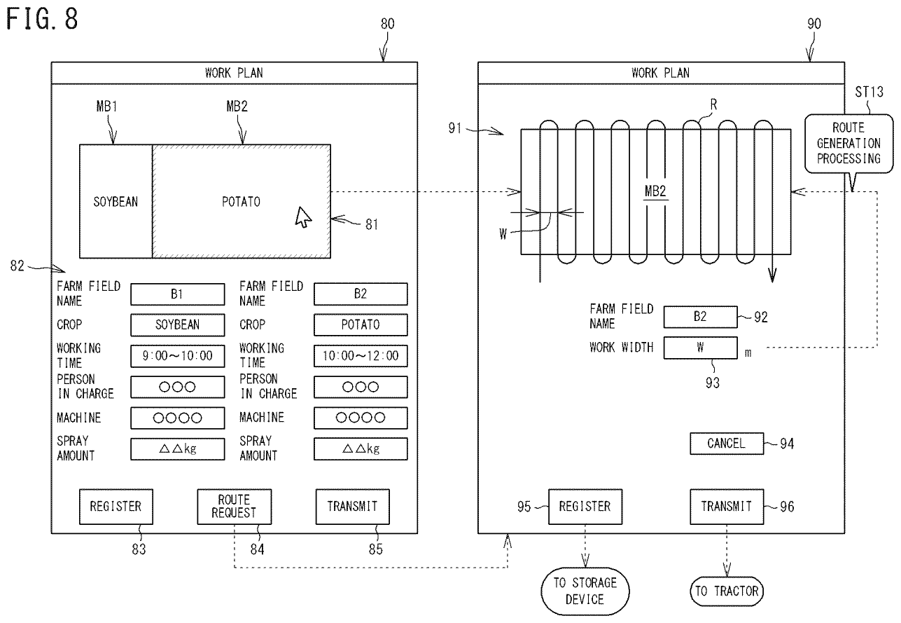

Specifically, FIG. 6 is an explanatory diagram illustrating an example of an initial setting screen 60 and a division setting screen 70. FIG. 7 is an explanatory diagram illustrating an example of the division setting screen 70 and a content confirmation screen 80. FIG. 8 is an explanatory diagram illustrating an example of the content confirmation screen 80 and a route setting screen 90.

As described above, when the division setter 59 of the setting screen 50 of the work plan is operated, the controller 41 of the server 40 causes the management terminal 30 to display the initial setting screen 60 illustrated in FIG. 6.

As illustrated in FIG. 6, the initial setting screen 60 includes, for example, a farm field display 61, a farm field selector 62, a cancel button 63, and an OK button 64.

The digital map included in the farm F including the plurality of farm fields Ai (i=1 to 8 in the illustrated example) is displayed in the farm field display 61. A farm field name Ai is superimposed and written inside each farm field included in the digital map.

Current state information of the farm field Ai is displayed in the farm field selector 62. The current state information of the farm field Ai includes, for example, “farm field name”, “address”, “area”, and the like of each farm field Ai included in the farm F. These pieces of information are information registered in advance in the storage device 42 of the server 40.

The cancel button 63 is an operation input interface for canceling the selection of the farm field Ai. The OK button 64 is an operation input interface for confirming the selection of the farm field Ai.

When a click operation occurs in a state in which a cursor is present in any one of the farm fields Ai listed in the farm field selector 62, selection of the clicked farm field Ai is temporarily determined. When the cancel button 63 is operated in this state, the temporary determination is canceled, and when the OK button is operated in this state, the temporary determination is confirmed. Here, it is assumed that the selection of the farm field A1 is confirmed.

When the farm field A1 is selected, the controller 41 of the server 40 executes generation processing of a farm field map MA in a predetermined data format corresponding to the selected farm field A1 (step ST11).

Specifically, the controller 41 of the server 40 executes the generation processing of the farm field map MA by the following procedures 11 to 13. Note that the controller 41 once records the generated farm field map MA in its own memory.

Procedure 11: The position information (for example, a series of position data groups) of the selected farm field A1 is read from the storage device 42.

Procedure 12: A plurality of linear equations capable of linear approximation is determined from the read position data groups.

Procedure 13: An intersection of the determined linear equations is set as a corner point of the farm field A1, and a region surrounded by the determined plurality of linear equations is set as the farm field map MA.

In the case of the procedures 11 to 13 described above, the series of position data groups registered in advance in the storage device 42 corresponds to “boundary information” for defining the boundary line of the farm field A1.

The data format of the farm field map MA is, for example, a plurality of linear equations (four linear equations in the case of a quadrangle) that is an approximate equation of the extension of the farm field A1. In addition, since the boundary information including the series of position data groups described above is registered in the storage device 42 of the server 40, the storage device 42 corresponds to an acquisition device of the boundary information.

When the OK button 64 on the initial setting screen 60 is operated, the controller 41 of the server 40 causes the management terminal 30 to display the division setting screen 70 illustrated in FIG. 6.

As illustrated in FIG. 6, the division setting screen 70 includes, for example, a map display 71, a target display 72, a planting setter 73, an area setter 74, an information confirmer 75, a cancel button 76, and an OK button 77.

In the map display 71, the farm field map MA (farm field map of farm field A1) once recorded in the memory is displayed. The farm field map MA is displayed with reference icons S1 to S4 attached to respective sides.

The reference icons S1 to S4 are icons to define a reference side, and the reference side is a side with which a division line Ld to be described later holds parallelism. Thus, for example, when the reference icon S1 on the left side is selected, the division line Ld becomes a line segment parallel to the left side of the farm field map MA.

In the target display 72, the current state information (for example, farm field name, address, and area) of the selected farm field A1 (farm field A1 before division) is displayed.

The planting setter 73 is a setter that receives inputs of the type of crops to be planted in the farm field after division and the reference side. In the example of the drawing, “soybean” is input to a crop name 1, “potato” is input to a crop name 2, and “S1” is input to the reference side. Note that the crop name 1 means a crop in a farm field closer to the reference side, and the crop name 2 means a crop farther from the reference side.

The area setter 74 is a setter that receives an input of the area of the farm field after division (hereinafter, also referred to as “divided farm field”).

In the example of the drawing, “0.5 ha” is input as the area of the divided farm field corresponding to the crop name 1, and “1.5 ha” is input as the area of the divided farm field corresponding to the crop name 2. In a case where an area that is too small to be planted or an area that is equal to or larger than the area of the farm field A1 is input, the controller 41 causes the division setting screen 70 to display a pop-up window for warning that input is impossible.

When there is an operation input to the planting setter 73 and the area setter 74, the controller 41 of the server 40 executes the division processing of dividing the farm field A into a plurality of divided farm fields based on the input information to the setters 73 and 74 (step ST12).

The division processing described above is, for example, processing of defining the division line Ld that divides the farm field A1 into a plurality of divided farm fields B1 and B2 each including a plantable area.

Specifically, the controller 41 of the server 40 executes the division processing for dividing the farm field A1 into a plurality of divided farm fields B1 and B2 by the following procedures 21 to 24.

Procedure 21: A relational equation between the area of the divided farm field B1 (for example, shape is rectangle) closer to the reference side S1 and a distance x from the reference side S1 to the division line Ld is read from the storage device 42.

Procedure 22: An area value (here, “0.5 ha”) input to the area setter 74 is substituted into the read relational equation to calculate a position xd of the division line Ld from the reference side S1.

Procedure 23: The division line Ld separated from the reference side S1 by the position xd is drawn on the farm field map MA displayed on the map display 71.

Procedure 24: A region from the reference side S1 to the division line Ld is set as a map MB1 of the divided farm field B1 (hereinafter, referred to as “divided farm field map MB1”) corresponding to the crop name 1 (soybean in the example of the drawing), and a region opposite to the reference side S1 as viewed from the division line Ld is set as a map MB2 of the divided farm field B2 (hereinafter, referred to as “divided farm field map MB2”) in which the crop name 2 (potato in the example of the drawing) is planted.

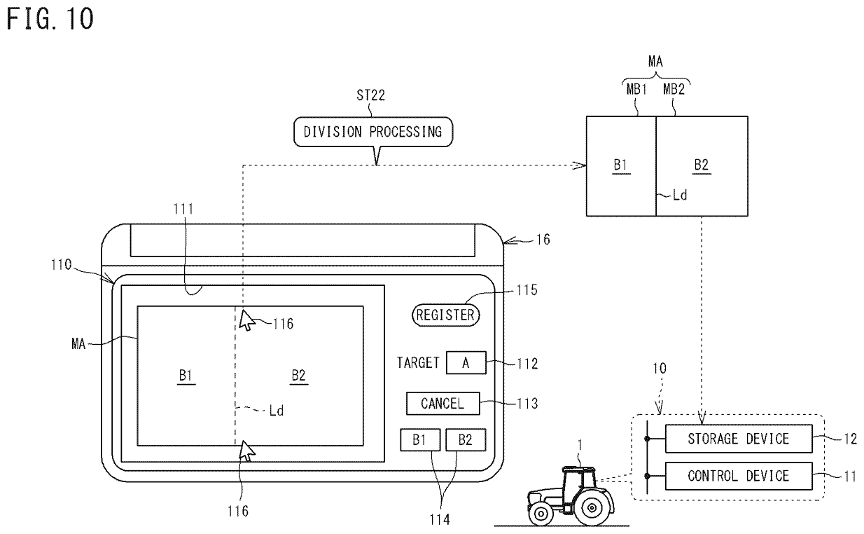

Note that the position of the division line Ld may be determined by specifying the start and end of the division line Ld by the operation input using a “pointer” displayed on the map display 71 in FIG. 6, similarly to the case of the division processing (step ST22) in FIG. 10 described later.

In the information confirmation unit 75, the current state information of the divided farm fields B1 and B2 is displayed. The current state information of the divided farm fields B1 and B2 includes, for example, “farm field name”, “crop”, “area”, and the like of the divided farm fields B1 and B2. Note that the administrator can change the names of the divided farm fields B1 and B2 by inputting a text in the column of “farm field name” of the information confirmation unit 75.

The cancel button 76 is an operation input interface for canceling a definition of the divided farm fields B1 and B2, and the OK button 77 is an operation input interface for confirming the definition.

Therefore, when the cancel button 76 is operated, the controller 41 of the server 40 deletes the position xd of the division line Ld from the memory, and causes the division setting screen 70 to display a pop-up window prompting reinput to the planting setter 73 and the area setter 74.

When the OK button 77 is operated, the controller 41 of the server 40 causes the management terminal 30 to display the content confirmation screen 80 illustrated in FIG. 7.

As illustrated in FIG. 7, the content confirmation screen 80 includes, for example, a map display 81, a work setter 82, a registration operation interface 83, a route requester 84, and a transmission operation interface 85.

In the map display 81, the shapes of the divided farm field maps MB1 and MB2 confirmed by the division processing and the names of crops planted in the divided farm fields B1 and B2 are displayed.

The work setter 82 is a setter that defines work content performed in each of the divided farm fields B1 and B2. The setting items of the work content can include, for example, “farm field name”, “crop”, “working time”, “person in charge”, “machine”, and “spray amount”.

The names of the farm fields (B1 and B2 in the example of the drawing) and the names of the crops (soybean and potato in the example of the drawing) determined on the division setting screen 70 are automatically written in the items of “farm field name” and “crops” among the setting items described above.

By text input, selection of a pull-down menu, or the like, the administrator can perform predetermined setting input in the items of “working time”, “person in charge”, “machine” (this means an implement mounted on the tractor 1), and “spray amount” among the setting items described above.

The registration operation interface 83 is an operation interface for registering information displayed on the content confirmation screen 80 in the storage device 42.

Therefore, when the administrator operates the registration operation interface 83, the controller 41 of the server 40 stores the confirmed information including the divided farm field maps MB1 and MB2 in a predetermined database constructed in the storage device 42.

The route requester 84 is an operation interface for requesting generation of a travel route for automatic driving for any of the divided farm field maps B1 and B2 displayed on the map display 81. Details of the generation processing of the travel route will be described later.

The transmission operation interface 85 is an operation interface for transmitting information displayed on the content confirmation screen 80 to the tractor 1. Therefore, when the administrator operates the transmission operation interface 85, the controller 41 of the server 40 controls the communication device 43 so that the confirmed information including the divided farm field maps MB1 and MB2 is transmitted to the tractor 1.

As illustrated in FIG. 8, when the route requester 84 is operated after the divided farm field map B2 of the map display 81 is activated by, for example, a click operation, the controller 41 of the server 40 causes the management terminal 30 to display the route setting screen 90.

As illustrated in FIG. 8, the route setting screen 90 includes, for example, a map display 91, a name display 92, a work width setter 93, a cancel button 94, a registration operation interface 95, and a transmission operation interface 96.

The divided farm field map MB2 selected (here, it is assumed that “MB2” is selected) in the map display 81 is displayed in the map display 91. In the name display 92, the farm field name B2 of the selected map MB2 is displayed.

The work width setter 93 is a setter that receives an input of a work width W of the tractor 1. The work width W is a width dimension between adjacent straight routes in a case where the tractor 1 automatically travels.

The work width W may be automatically determined by the controller 41 from the type of the implement 8 set by the work setter 82 of the content confirmation screen 80.

When the work width W is input to the work width setter 93, the controller 41 of the server 40 executes generation processing of a travel route in a case where work travel is performed by automatic driving (step ST13). Specifically, the controller 41 executes the generation processing of a travel route R for the divided farm field map MB2 by the following procedures 31 to 34.

Procedure 31: With the variable of a route number as “n”, an “n-th route” representing a group of straight lines parallel to a reference direction (for example, the direction of the reference side S1) of the divided farm field map MB2 is defined.

Procedure 32: A straight line away from one edge of the divided farm field map MB2 by a predetermined distance (for example, W/2) is set as a first route.

Procedure 33: A straight line away from the first route by the work width W is set as a second route.

Procedure 34: The procedure 33 is repeated until the n-th route reaches the vicinity of the other end edge of the divided farm field map MB2.

Procedure 35: The end of the n-th route and the start of the (n+1)-th route are connected by a semicircular route to form one travel route R that reciprocates in the reference direction inside the divided farm field map MB2.

The registration operation interface 95 is an operation interface for registering, in the storage device 42, the travel route R for automatic driving generated using the route setting screen 90.

Therefore, when the administrator operates the registration operation interface 95, the controller 41 of the server 40 stores the travel route R in a case where the tractor 1 automatically travels in the divided farm field map MB2, in a predetermined database constructed in the storage device 42.

The transmission operation interface 96 is an operation interface for transmitting, to the tractor 1, the travel route R for automatic driving generated using the route setting screen 90.

Therefore, when the administrator operates the transmission operation interface 96, the controller 41 of the server 40 controls the communication device 43 so that the travel route R in the case where the tractor 1 automatically travels the divided farm field map MB1, is transmitted to the tractor 1.

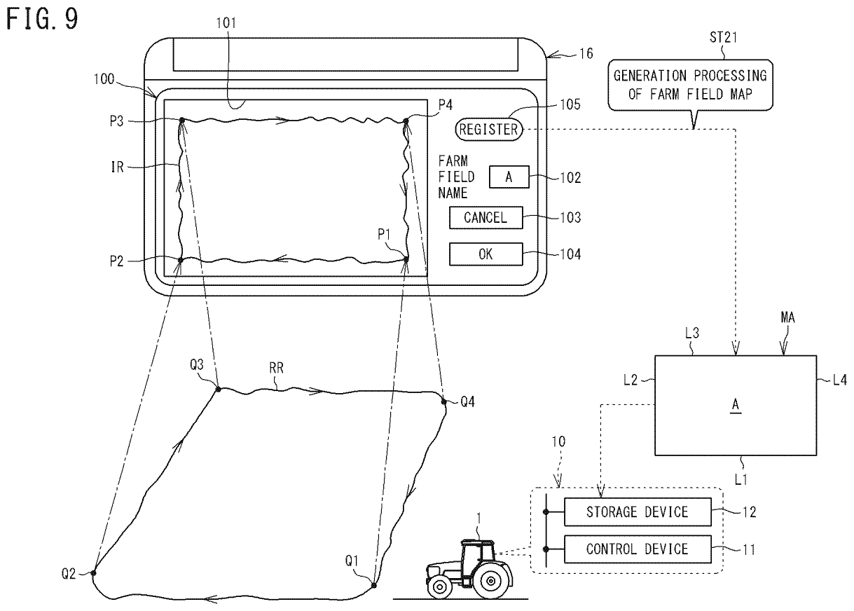

FIG. 9 is an explanatory diagram illustrating an example of registration processing of the farm field map MA executed by the controller 11 of the tractor 1. The meaning of each of the parameters illustrated in FIG. 9 is as follows.

RR: This is a traveling trajectory in a case where the tractor 1 actually travels a predetermined place of the farm. Hereinafter, it is referred to as a “real route RR”.

Q1 to Q4: These are points where the tractor 1 changes its traveling direction by a predetermined angle or more in the real route RR. Hereinafter, each of them is referred to as a “real turning point Qj” (j=1 to 4).

IR: This is a traveling trajectory of the tractor 1 on the digital map corresponding to the real route RR. Hereinafter, it is referred to as an “imaginary route IR”.

P1 to P4: These are direction turning points of the tractor 1 on the digital map corresponding to the real turning point Qj. Hereinafter, each of them is referred to as an “imaginary turning point Pj” (j=1 to 4).

As illustrated in FIG. 9, the controller 11 of the tractor 1 can execute a “farm field registration mode” using a farm field registration screen 100 displayed by the operation terminal 16.

The farm field registration screen 100 used in the farm field registration mode includes, for example, a tracking screen 101, a name setter 102, a cancel button 103, an OK button 104, and a registration operation interface 105. A name (here, “A”) of an arbitrary farm field defined by the occupant of the tractor 1 can be input to the name setter 102.

In the farm field registration mode, a trajectory along which the tractor 1 has traveled is drawn on a tracking screen 101 of the farm field registration screen 100. Specifically, the controller 11 draws the current position acquired from the positioning device 15 on the digital map of the tracking screen 101.

When the occupant of the tractor 1 operates the OK button 104 while traveling, a point where the operation input is made is regarded as a real turning point Qj. In this case, the controller 11 temporarily determines the imaginary turning point Pj corresponding to the real turning point Qj and once records the imaginary turning point Pj in the memory.

Therefore, when the tractor 1 travels in the farm on the real route RR of a closed loop and the occupant operates the OK button 104 in the middle of traveling, the controller 11 records, in the memory, the imaginary route IR corresponding to the real route RR and the plurality of imaginary turning points Pj corresponding to the respective real turning points Qj.

The occupant of the tractor 1 can determine whether the farm field A surrounded by the imaginary route IR is appropriate based on the shape of the imaginary route IR drawn on the tracking screen 101.

In a case where the occupant of the tractor 1 determines that the drawn imaginary route IR is inappropriate, the occupant just operates the cancel button 103. In this case, the controller 11 deletes the imaginary route IR and the imaginary turning points Pj once recorded in the memory.

In a case where the occupant of the tractor 1 determines that the drawn imaginary route IR is appropriate, the occupant operates the registration operation interface 105. In this case, the controller 11 of the tractor 1 executes generation processing of the farm field map MP (step ST21).

Specifically, the controller 11 of the tractor 1 executes the generation processing of the farm field map MA by the following procedures 41 to 43, and causes the storage device 12 to store the generated farm field map MA.

Procedure 41: A plurality of linear equations L1 to L4 capable of linear approximation is determined from a trajectory between adjacent imaginary turning points Pj and Pj+1 among traveling trajectories constituting the imaginary route IR. Note that the linear equations L1 to L4 may be equations in a case where the adjacent imaginary turning points Pj and Pj+1 are connected by a straight line.

Procedure 42: A region surrounded by the plurality of determined linear equations L1 to L4 is set as the farm field map MA.

Procedure 43: An intersection of the determined linear equations L1 to L4 is set as a corner point of the farm field map MA.

In the case of the procedures 41 to 43 described above, a series of position data groups of the real route RR, which is original data of the imaginary route IR, corresponds to “boundary information” for defining the boundary line of the farm field A.

The data format of the farm field map MA is the linear equations L1 to L4 which are approximate equations of the extension of the farm field A. In addition, the communication device 13 that receives the series of position data groups of the boundary information corresponds to an acquisition device of the boundary information.

FIG. 10 is an explanatory diagram illustrating an example of the division processing of the farm field map MA executed by the controller 11 of the tractor 1.

As illustrated in FIG. 10, the controller 11 of the tractor 1 can execute a “farm field division mode” using a farm field division screen 110 displayed by the operation terminal 16.

The farm field division screen 110 used in the farm field division mode includes, for example, a map display 111, a target selector 112, a cancel button 113, a name setter 114, and a registration operation interface 115.

A name (here, “B1” and “B2”) of an arbitrary divided farm field defined by the occupant of the tractor 1 can be input to the name setter 114.

In the farm field division mode, the farm field map MA of the farm field name (here, “A”) input to the target selector 112 is drawn in the map display 111 of the farm field division screen 110.

Next, the controller 11 of the tractor 1 executes the division processing of dividing the farm field A into a plurality of divided farm fields (step ST22).

The division processing described above is, for example, processing of defining the division line Ld that divides the farm field A into a plurality of divided farm fields B1 and B2 each including a plantable area.

Specifically, when the occupant designates the start and end on the boundary line of the farm field map MA by a pointer 116 displayed on the map display 111, the controller 11 of the tractor 1 draws a division line Ld including the designated start and end point on the map display 111.

In addition, the controller 11 once records the position data of the division line Ld (for example, the coordinates of the start and end) in the memory. Note that, in a case where a region that is too small to be planted is designated, the controller 41 causes the farm field division screen 110 to display a pop-up window for warning that input is impossible.

In a case where the occupant of the tractor 1 determines that the drawn division line Ld is inappropriate, the occupant just operates the cancel button 113. In this case, the controller 11 deletes the position data of the division line Ld once recorded in the memory.

In a case where the occupant of the tractor 1 determines that the drawn division line Ld is appropriate, the occupant operates the registration operation interface 115. In this case, the controller 11 of the tractor 1 determines each region of the farm field map MA divided by the division line Ld as the divided farm field maps MB1 and MB2.

In addition, the controller 11 causes the storage device 12 to store the determined maps MB1 and MB2 together with the farm field names B1 and B2, respectively.

Note that, similar to the case of the division processing (step ST12) in FIG. 6 described above, an “area setter” may be provided in the farm field division screen 110 in FIG. 10, and the position of the division line Ld may be determined based on the area value input to the area setter.

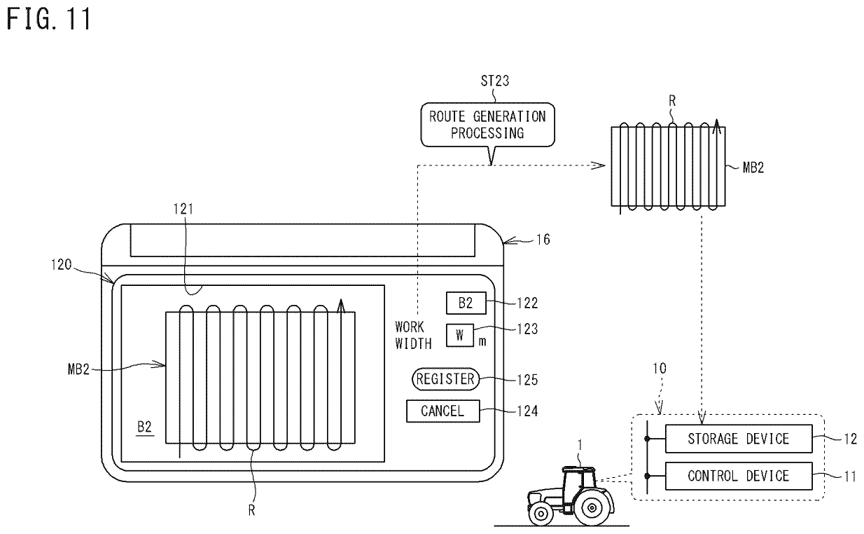

FIG. 11 is an explanatory diagram illustrating an example of the generation processing of the travel route R executed by the controller 11 of the tractor 1.

As illustrated in FIG. 11, the controller 11 of the tractor 1 can execute a “route generation mode” using a route setting screen 120 displayed by the operation terminal 16.

The route setting screen 120 used in the route generation mode includes, for example, a map display 121, a target selector 122, a work width setter 123, a cancel button 124, and a registration operation interface 125.

The divided farm field map MB2 selected (here, it is assumed that “B2” is selected) in the target selector 122 is displayed in the map display 121. In the map display 121, the farm field name B2 of the selected map MB2 is also displayed.

The work width setter 123 is a setter that receives an input of a work width W of the tractor 1. The work width W is a width dimension between adjacent straight routes in a case where the tractor 1 automatically travels.

Note that the work width W may be automatically determined by the controller 11 from the type of the implement currently mounted or to be mounted.

When the work width W is input to the work width setter 123, the controller 11 of the tractor 1 executes the generation processing of the travel route R in a case where work travel is performed by automatic driving (step ST23).

Specifically, the controller 11 executes the generation processing of the travel route R for the divided farm field map MB2 by the procedures 31 to 34 described above. In addition, the controller 11 once records the generated travel route R in the memory, superimposes the generated travel route R on the divided farm field map MB2, and draws the generated travel route R on the map display 121.

In a case where the occupant of the tractor 1 determines that the drawn travel route R is inappropriate, the occupant just operates the cancel button 124. In this case, the controller 11 deletes the position data of the travel route R once recorded in the memory.

The registration operation interface 126 is an operation interface for registering, in the storage device 42, the generated travel route R for automatic driving. Therefore, in a case where the occupant of the tractor 1 determines that the drawn travel route R is appropriate, the occupant operates the registration operation interface 126.

In this case, the controller 11 of the tractor 1 causes the storage device 12 to store the position data of the generated travel route R in association with the divided farm field map MB2.

Note that, in the route generation mode of FIG. 11, the divided farm field map MB2 selected by the target selector 122 may be not only the map generated by the controller 11 of the tractor 1 but also the divided farm field map MB2 provided from the server 40.

The example embodiments disclosed herein are illustrative in all respects and is not restrictive. The scope of the present invention is not limited to the example embodiments described above, and includes all modifications within the scope equivalent to the configurations described in the claims.

In the example embodiments described above, the case where one farm field map is divided into two divided farm field maps has been exemplified, but one farm field map may be divided into three or more divided farm field maps.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A farm field registration device comprising:
an acquisition device configured to acquire boundary information for defining a boundary line of a farm field;
a controller configured or programmed to create a farm field map in a predetermined data format based on the boundary information; and
a storage device configured to store the farm field map; wherein
the acquisition device is configured to acquire division information for defining a division line that divides the farm field into a plurality of divided farm fields each including a plantable area;
the controller is configured or programmed to execute division processing of creating a divided farm field map corresponding to the plurality of divided farm fields based on the division information; and
the storage device is configured to store the divided farm field map.

2. The farm field registration device according to claim 1, wherein
the division information includes areas of the plurality of divided farm fields; and
the division processing includes processing of determining, based on the areas, a position of the division line by moving at least one side of the farm field map in parallel to a center side.

3. The farm field registration device according to claim 2, wherein
the acquisition device is configured to acquire types of crops to be planted in the plurality of divided farm fields; and
the division processing includes processing of determining a map to which one of the types of crops is to be associated among the plurality of divided farm field maps.

4. The farm field registration device according to claim 1, wherein
the farm field registration device is a management device configured to communicate with an agricultural machine configured to perform automatic driving; and
the management device is configured to transmit the plurality of divided farm field maps to the agricultural machine.

5. The farm field registration device according to claim 1, wherein the controller is configured or programmed to generate a travel route of an agricultural machine in a case where the agricultural machine performs work travel by automatic driving, for each of the plurality of divided farm field maps.

6. The farm field registration device according to claim 5, wherein
the farm field registration device is a management device configured to communicate with an agricultural machine configured to perform automatic driving; and
the management device is configured to transmit the travel route generated by the controller to the agricultural machine.

7. The farm field registration device according to claim 5, wherein
the farm field registration device is an agricultural machine configured to perform automatic driving; and
the agricultural machine is configured to generate a travel route in a case of performing work travel by automatic driving, for each of the plurality of divided farm field maps received from the management device.

8. The farm field registration device according to claim 1, wherein
the farm field registration device is an agricultural machine configured to perform automatic driving; and
the agricultural machine is configured to generate a travel route in a case of performing work travel by automatic driving, for each of the plurality of divided farm field maps created by the division processing.

9. A farm field registration method executed by a farm field registration device including an acquisition device configured to receive input of boundary information for defining a boundary line of a farm field, a controller configured or programmed to create a farm field map in a predetermined data format based on the boundary information, and a storage device configured to store the farm field map, the farm field registration method comprising:
acquiring division information for defining a division line that divides the farm field into a plurality of divided farm fields each including a plantable area;
executing division processing of calculating a divided farm field map corresponding to the plurality of divided farm fields based on the division information; and
storing the divided farm field map.

10. A non-transitory computer readable storage medium storing a computer program to cause a computer to function as a farm field registration device including an acquisition device configured to receive input of boundary information for defining a boundary line of a farm field, a controller configured or programmed to create a farm field map in a predetermined data format based on the boundary information, and a storage device configured to store the farm field map, the computer program causing the farm field registration device to perform a method comprising:
acquiring division information for defining a division line that divides the farm field into a plurality of divided farm fields each including a plantable area;
executing division processing of calculating a divided farm field map corresponding to the plurality of divided farm fields based on the division information; and
storing the divided farm field map.
